(19) United States
(12) Patent Application Publication
(10) Pub. No.: US 2003/0022544 A1
(43) Pub. Date: Jan. 30, 2003

(54) Connector

(75) Inventor: Yasuhiro Hattori, Nagoya-shi (JP)

Correspondence Address: OLIFF & BERRIDGE, PLC, P.O. BOX 19928, ALEXANDRIA, VA, 22320, US

(73) Assignee: AUTONETWORKS TECHNOLOGIES, LTD., Nagoya-shi (JP)

(21) Appl. No.: 10/161,614

(22) Filed: Jun. 5, 2002

(30) Foreign Application Priority Data
Jun. 7, 2001 (JP) P.2001-171948

(51) Int. Cl. H01R 13/627

(52) U.S. Cl. 439/350

(57) ABSTRACT

When male and female connectors 11 and 12 are to be disjointed, terminals 13 and 14 are disconnected from each other always after projections 16 and 17 are unlocked, by setting S1<S2, wherein the sliding stroke necessary for releasing the lock by the projections 16 and 17 is indicated by S1, and the sliding stroke necessary for disconnecting the female terminals 13 and 14 from each other is indicated by S2.

### BACKGROUND OF THE INVENTION

The present invention relates to a connector to be used in the wire connections of an automobile or the like.

The connector of this kind is constructed of male and female connector members 1 and 2, as shown in FIGS. 9 and 10.

The male connector member 1 and the female connector member 2 are provided with a male terminal 3 and a female terminal 4, respectively, which confront each other. The connector is constructed such that the connector members 1 and 2 are jointed/disjointed to/from each other, when slid in directions to approach/leave each other (or in the longitudinal directions of the terminals), and the terminals 3 and 4 are connected/disconnected.

Here, the female terminal 4 is provided with an elastic contact 5 made of a leaf spring or the like, and an electrically connected state is established when the male terminal 3 makes elastic contact with the elastic contact 5.

Moreover, the connector members 1 and 2 are provided on their outer faces with locking projections 6 and 7, which come into engagement with each other, as shown in FIG. 9, when the connector members 1 and 2 are jointed, to lock the connector members 1 and 2 in the jointed state.

These projections 6 and 7 are engaged/disengaged by enabling at least one of them elastically to protrude freely.

Numerals 8 and 9 designate electric wires, to which the terminals 3 and 4 are attached, and numerals 1a and 2a designate connector housings of the connector members 1 and 2.

FIG. 10 shows the state in which the connector members 1 and 2 are slid apart from each other to release the engagement (or lock) of the projections 6 and 7 so that they may be disjointed from each other. The connector members 1 and 2 are disjointed by sliding them further from the state of FIG. 10.

Here in the connector of the prior art, the positional relations between the terminals 3 and 4 and the lock means are so set that the unlock is substantially timed with the disconnection of the terminals 3 and 4, as shown in FIG. 10.

If the sliding stroke necessary for disconnecting the terminals 3 and 4 is indicated by X and if the sliding stroke necessary for releasing the lock is indicated by Y, more specifically, the connector is constructed:

such that the following relation is set:

X≈Y; and

such that the terminals 3 and 4 are disconnected at the instant (or just before or after an extremely short time) when the lock is released.

By an obstruction to the disjoint for releasing the lock, therefore, the disconnection of the terminals 3 and 4 is delayed to cause an arc discharge easily between the terminals when the connector is disjointed with the lines being live. This arc discharge may damage the terminals 3 and 4 (e.g., the elastic contact 5 of the female terminal 4) or the like.

The following Table 1 numerates relations among an electric current fed, an extracting (or disjointing) rate of the connector members and the frequency of the damages of a terminal (or the elastic contact of the female terminal) due to the arc discharge.

TABLE 1
Frequency of Damages when Connector Active line Is Extracted
at Voltage of 42 V:

| Extracting | | | | | | | | | | |
|---|---|---|---|---|---|---|---|---|---|---|
| Rate | Current Value (A) | | | | | | | | | |
| (mm/min) | 1 | 2 | 5 | 10 | 20 | 25 | 30 | 40 | 60 | 80 |
| 100 | ◯ | X | | XX | XX | | | XX | XX | XX |
| 1000 | | | ◯ | ◯ | X | | XX | | | |
| 2500 | | | ◯ | ◯ | ◯ | ◯ | X | | | |
| 5000 | | | | ◯ | ◯ | ◯ | ◯ | X | | |
| 10000 | | | | | | | ◯ | ◯ | X | X |
| 30000 | | | | | | | | | ◯ | |
| 50000 | | | | | | | | | | ◯ |

◯: No Serious Damage after 10 Extractions of Live Wire
X: Damages to Elastic Contact after 10 Extractions of Live Wire
XX: Serious Damages

It is apparent from Table 1 that the damages are the more serious at the lower extracting rate and under the higher power current. The solution of this problem was awaited the more as the voltage becomes the higher in recent years.

### SUMMARY OF THE INVENTION

Therefore, the invention provides a connector capable of preventing the arc discharge at a disconnecting time.

According to the invention of Aspect 1, there is provided a connector comprising: male and female connector members enabled to be jointed to and disjointed from each other; male and female terminals adapted to be electrically connected with each other when the connector members are jointed; and lock means for locking the connector members disjointably, the connected states of the terminals are still kept even after the lock means is released to lose its obstruction to the disjoint of the connector members.

In the construction of Aspect 1, according to the invention of Aspect 2, by the sliding motions in the directions for the male and female connector members to approach and leave each other, the following steps are made:

(a) the jointing/disjointing step of the male and female connector members;

(b) the connecting/disconnecting step of the terminals; and

(c) the locking/unlocking step of the lock means, and a sliding stroke S1 necessary for releasing the lock of the lock means and a sliding stroke S2 necessary for disconnecting the terminals are set to satisfy the following relation:

S1<S2.

In the construction of Aspect 2, according to the invention of Aspect 3, the male and female connector members are provided with seal members adapted to be brought into and out of contact with each other by the sliding motions of the connector members for water-tight sealing/unsealing the connected portions of the male and female terminals, and a sliding stroke S3 necessary for releasing the seal of the seal members is set to satisfy the following relation:

S2>S3.

According to the construction thus far-described, the terminals can be disconnected, after the lock is released, in a state without any obstruction to the disjoint by the lock means, so that the disconnection can be quickly made. Therefore, the arc is hardly discharged between the terminals at that terminal disconnecting time. Even under a high voltage, therefore, it is possible to suppress the damage by the arc discharge.

In this case, according to the construction of Aspect 2, the aforementioned effects can be attained by setting such relations between the lock means and the connected portions of the terminals that the sliding stroke S2 necessary for the releasing the lock of the lock means is smaller than the sliding stroke S1 necessary for disconnecting the terminals, in the most general connector, as exemplified in the prior art, in which the connector members and the terminals are jointed (or connected)/disjointed by the sliding motions.

According to the invention of Aspect 3, moreover, the aforementioned effects can be attained by constructing a water-proof connector for protecting the connected portions of the terminals against water with the seal member such that the connected state of the terminals may be still kept even when the obstruction to the disjoint of the connector by both the lock means and the seal member disappears.

### BRIEF DESCRIPTION OF THE DRAWINGS

FIG. 1 is a sectional view showing a state before a connector according to a first embodiment of the invention is jointed.

FIG. 2 is a sectional view of the jointed state of the same.

FIG. 3 is a sectional view of the state in which the lock is released from the jointed state.

FIG. 4 is a sectional view of the state in which the terminals are further disconnected from the state of FIG. 3.

FIG. 5 is a sectional view showing a state before a connector according to a second embodiment of the invention is jointed.

FIG. 6 is a sectional view of the jointed state of the same.

FIG. 7 is a sectional view of the state in which the lock is released from the jointed state.

FIG. 8 is a sectional view of the state in which the terminals are further disconnected from the state of FIG. 7.

FIG. 9 is a sectional view of the jointed state of a connector of the prior art.

FIG. 10 is a sectional view showing the state in which the lock is released from the state of FIG. 9.

### DETAILED DESCRIPTION OF THE PREFERRED EMBODIMENTS

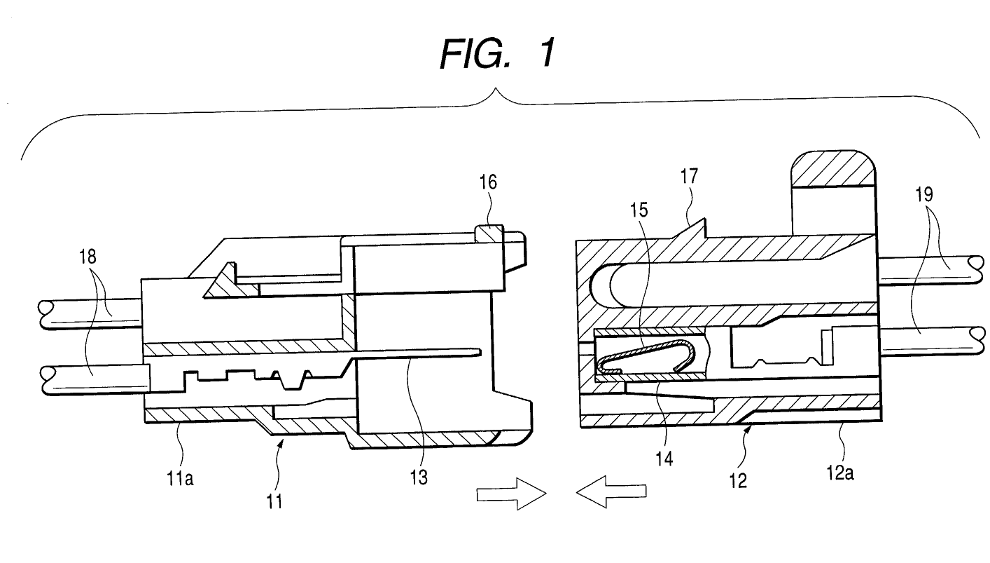

The invention will be described in connection with its embodiments with reference to FIGS. 1 to 8.

First Embodiment (as Referred to FIGS. 1 to 4):

The first embodiment is applied to a non-water-proof connector.

In the Drawings, numeral 11 designates a male connector member, and numeral 12 designates a female connector member. These male connector member 11 and female connector member 12 are provided with a male terminal 13 and a female terminal 14, respectively, which confront each other. The connector members 11 and 12 are provided with projections 16 and 17 as lock means.

Numeral 15 designates an elastic contact, and numerals 18, 18, 19 and 19 designate electric wires having the terminals 13 and 14. Numeral 11a designates a connector housing of the male connector member 11, and numeral 12a designates a connector housing of the female connector member 12.

In this connector like the connector of the prior art shown in FIGS. 9 and 10, by the sliding motions in the directions for the male and female connector members 11 and 12 to approach and leave each other (i.e., in the longitudinal directions of the terminals), the connector members 11 and 12 are jointed to/disjointed from each other, and the terminals 13 and 14 are connected with/disconnected from each other. At the time of jointing the connector members, moreover, the projections 16 and 17 are brought into engagement so that the connector members 11 and 12 are locked in the jointed state.

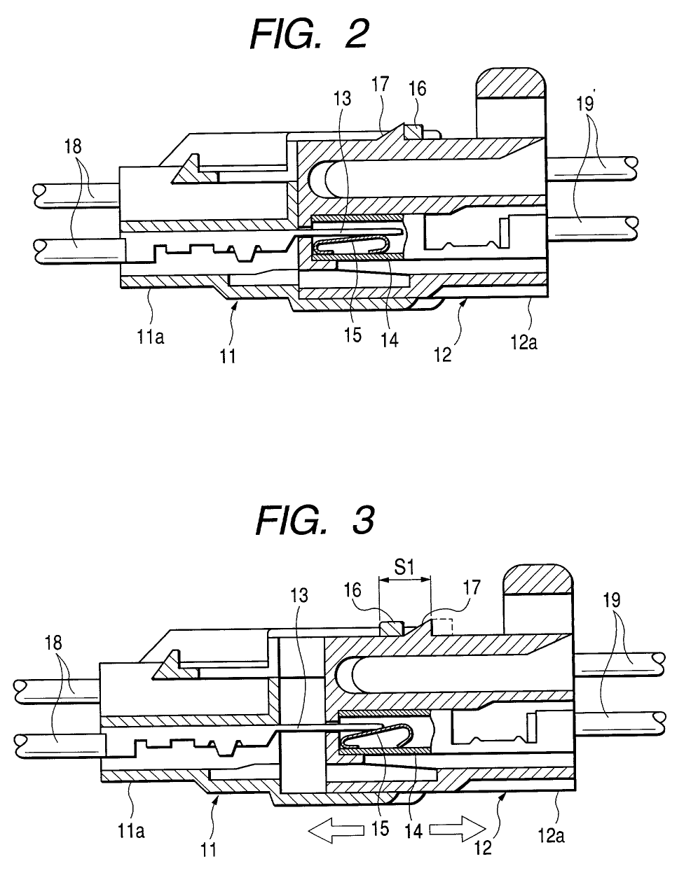

FIG. 1 shows a state before the connector members 11 and 12 are jointed, and FIG. 2 show a state in which the same are jointed. From this jointed state, the connector members 11 and 12 are slid in the disjointing directions, as shown in FIG. 3, to release the engagement (or lock) of the projections 16 and 17.

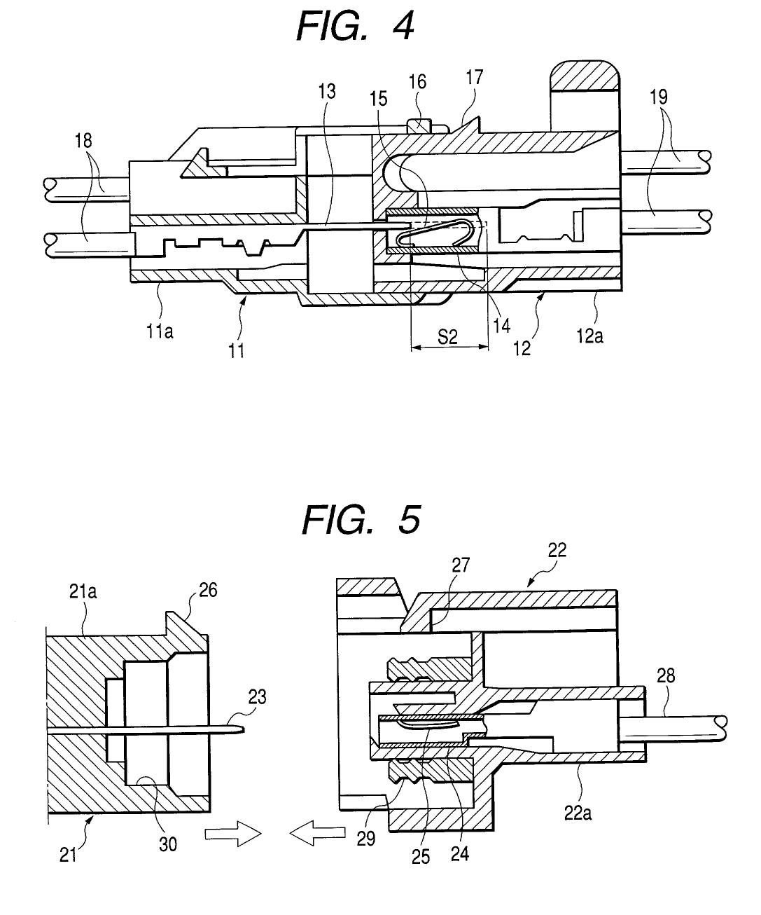

At this time, the terminals 13 and 14 are still in the connected state, as shown. By sliding the connector members 11 and 12 further in the disconnecting directions, the terminals 13 and 14 are disconnected. FIG. 4 shows the state of the instant, at which the terminals 13 and 14 are disconnected.

More specifically, this connector is constructed: such that if the sliding stroke necessary for releasing the engagement (or releasing the lock) of the projections 16 and 17 is indicated by S1 (as referred to FIG. 3) and if the sliding stroke necessary for disconnecting the terminals 13 and 14 from each other is indicated by S2 (as referred to FIG. 4), the following relation is set:

S1<S2; and

such that the terminals 13 and 14 are not disconnected from each other before the projections 26 and 27 are unlocked.

Thus, the terminals 13 and 14 can be quickly (or as fast as possible) disconnected in a state without any obstruction to the disjoint by the lock means (i.e., the projections 16 and 17), so that the arc is hardly discharged between the terminals at that terminal disconnecting time. Even under a high voltage, therefore, it is possible to suppress the damage of the terminals or the like, as might otherwise be caused the terminal arc discharge).

Second Embodiment (as Referred to FIGS. 5 to 8):

The second embodiment is applied to a water-proof connector.

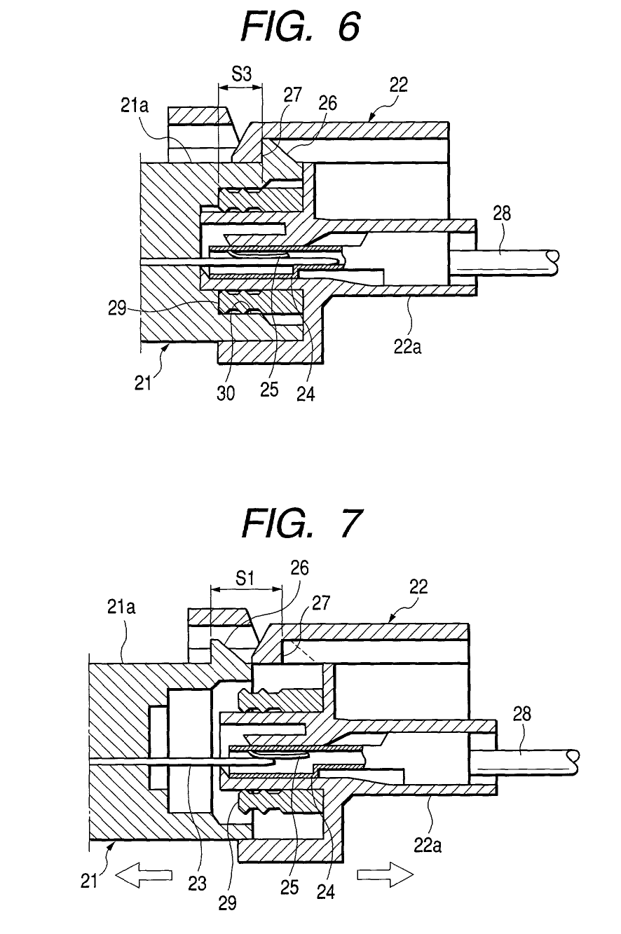

The description will be described exclusively on the differences from the first embodiment. Numeral 21 designates a male connector member, and numeral 22 designates a female connector member. These male connector member 21 and female connector member 22 are provided with a male terminal 23 and a female terminal 24, respectively, which confront each other. The connector members 21 and 22 are provided with projections 26 and 27 as lock means. Like the first embodiment, the connector members 21 and 22 are jointed to/disjoined from each other by the sliding motions in the longitudinal directions of the terminals, and the terminals 23 and 24 are connected to/disconnected from each other. At the jointing time of the connector members shown in FIG. 6, moreover, the projections 26 and 27 are brought into engagement so that the connector members 21 and 22 are locked in the jointed state.

Numeral 25 designates an elastic contact, and numeral 28 designates one electric wire having the female terminal 24 (although the other electric wire of the female terminal and the electric wires of the male terminal are not shown). Numeral 21a designates a connector housing of the male connector member 21, and numeral 22a designates a connector housing of the female connector member 22.

Moreover, this connector is provided as its water-proofing seal member with a cylindrical seal ring 29, which is disposed in the female connector member 22 and made of an elastic material such as rubber, and a cylindrical seal portion 30 which is disposed on the inner face of the male connector member 21. When the seal ring 29 comes into elastic contact with the seal portion 30 with the connector members 21 and 22 being jointed, as shown in FIG. 6, the connector member jointed portions are held water-tight so that the connected terminal portions are sealed water-proof.

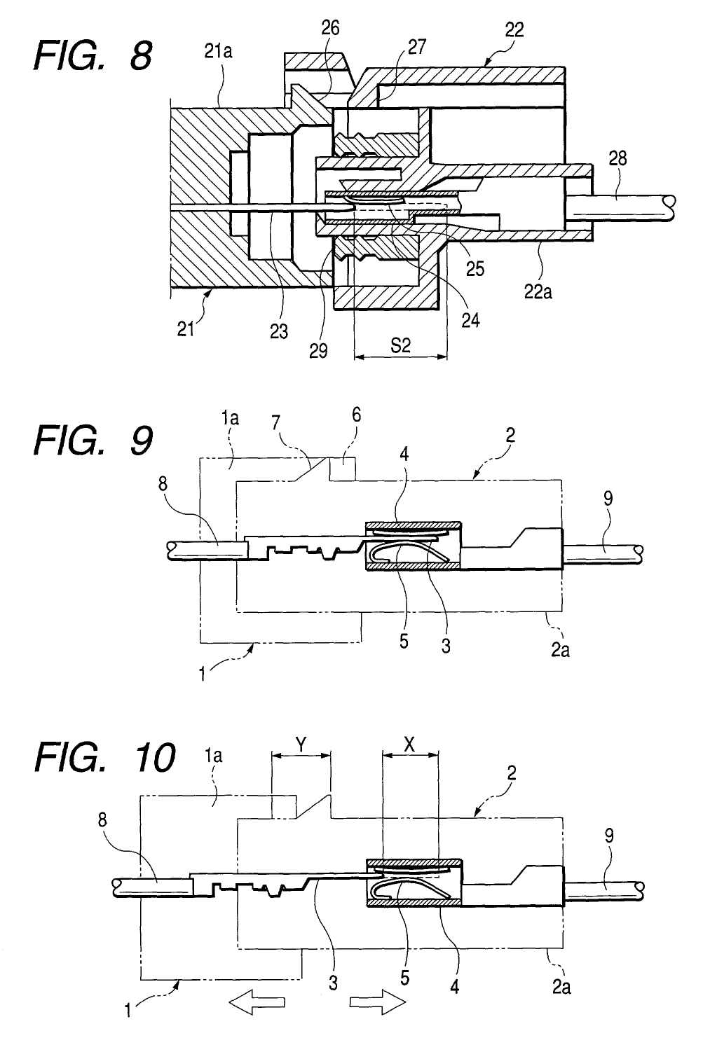

FIG. 7 shows the state in which the connector members 21 and 22 are slid in the disjointing directions from their jointed states to release the engagement (or release the lock) of the projections 26 and 27, and FIG. 8 shows the instant at which the terminals 23 and 24 are disconnected by further sliding the connector members 21 and 22.

This connector is constructed, like the connector of the first embodiment: such that if the sliding stroke necessary for releasing the engagement (or the lock) of the projections 26 and 27 from each other is indicated by S1 (as referred to FIG. 7), if the sliding stroke necessary for disconnecting the terminals 23 and 24 from each other is indicated by S2 (as referred to FIG. 8) and if the sliding stroke necessary for the seal ring 29 to be separated (or to be unsealed) from the seal portion 30 is indicated by S3 (as referred to FIG. 6), the following relations are set:

S1, S3<S2; and

such that the terminals 23 and 24 are not disconnected from each other before the projections 26 and 27 are unlocked or unsealed, as might otherwise obstruct the disjoint of the connector members 21 and 22.

In the water-proof connector thus constructed, too, the terminals 23 and 24 can be quickly disconnected to suppress the arc discharge.

Here, the foregoing two embodiments use the lock means for making the locking/unlocking actions by the sliding motions of the connector members 11 and 12, and 21 and 22. However, the lock means may be exemplified by the non-slide type lock means having the structure, in which the connector members being jointed are fastened and fixed by fitting a fastening clamp on the outer circumference of the connector or in which the connectors are locked by screwing a bolt into the connector from the outer circumference of the same.

In short, the connector may be so modified by using the non-slide type lock means that the terminal disconnecting action is made after the lock is released.

According to the invention, as is described hereinbefore, the terminals can be disconnected when the obstruction of the lock means (and the seal member in Aspect 3) to the disjoint disappears so that the disconnecting action can be quickly made. Therefore, the arc discharge hardly occurs between the terminals at the disconnecting time so that the damage from the arc distance can be suppressed even under a high voltage.

What is claimed is:

1. A connector comprising:
male and female connector members enabled to be jointed to and disjointed from each other;
male and female terminals adapted to be electrically connected with each other when said connector members are jointed; and
lock means for locking said connector members disjointably, the connected states of said terminals are kept after said lock means is released to lose a obstruction thereof to the disjoint of said connector members.

2. The connector according to claim 1, wherein
the sliding motions in the directions for said male and female connector members to approach and leave each other, comprises:
(a) jointing/disjointing step of said male and female connector members;
(b) connecting/disconnecting step of said terminals;
(c) locking/unlocking step of said lock means, and
a sliding stroke S1 necessary for releasing the lock of said lock means, and a sliding stroke S2 necessary for disconnecting said terminals are set to satisfy the following relation:
S1<S2.

3. The connector according to claim 2, wherein
said male and female connector members comprise seal members adapted to be brought into and out of contact with each other by the sliding motions of said connector members for water-tight sealing/unsealing the connected portions of said male and female terminals, and
a sliding stroke S3 necessary for releasing the seal of said seal members is set to satisfy the following relation:
S2>S3.
